(19) United States
(12) Patent Application Publication
(10) Pub. No.: US 2005/0060798 A1
(43) Pub. Date: Mar. 24, 2005

(54) Ventilated bedpan assembly

(76) Inventor: Robert L. Diaz, Palm Beach Gardens, FL (US)

Correspondence Address: Michael A. Slavin, Esq.;McHale & Slavin, P.A., 2855 PGA Boulevard, Palm Beach Gardens, FL, 33410, US

(21) Appl. No.: 10/671,336

(22) Filed: Sep. 24, 2003

(51) Int. Cl. A61G 9/00

(52) U.S. Cl. 4/453

(57) ABSTRACT

A bedpan having a ventilation unit having an integral ozone producing device for the purpose of odor elimination comprises a bedpan having at least one venting port in a side wall and a ventilation unit detachably connected to the bedpan at the venting port. The ventilation unit includes a plenum chamber having at least one intake opening and an outlet port in airflow communication with the venting port in the bedpan. An ozonation means is disposed in the plenum chamber; and airflow means, which may be a fan, is disposed in air flow communication with the plenum chamber to induce airflow through the outlet port. An electrical power supply means is constructed and arranged to operatively communicate with the ozonation means and the air flow means, e.g. the fan, as required. In an alternative embodiment, the ventilation unit is connected to the bedpan via a segment of flexible hose which allows airflow from the interior of the bedpan to the ventilation unit. A portable ventilation unit is also disclosed.

### FIELD OF THE INVENTION

This invention is related to bedpans and other similar receptacles, and in particular to a ventilation assembly for bedpans and the like which provides rapid odor elimination.

### BACKGROUND OF THE INVENTION

It is frequently necessary for invalids, bedridden hospital patients and persons otherwise infirm to use bedpans instead of plumbed toilet facilities. A responsible caregiver must place the bedpan in the appropriate position and then remove the used bedpan, and both the caregiver and the patient are subjected to the objectionable odor, which will remain in the ambient air unless proper ventilation is available.

It would be highly desirable to provide a bedpan with an integrated odor elimination system. In the prior art, patents having an objective of bedpan odor control are directed either to disposable bedpans or bedpan liners, and include Oberstein, U.S. Pat. No. 4,136,798, Scrafield et al., U.S. Pat. No. 4,011,606, and Royal, U.S. Pat. No. 5,224,233.

In order to provide an improved odor elimination system for bedpans, the present invention includes an ozone producing apparatus. As is known in the art, ozone is much more active chemically than ordinary oxygen and is a powerful oxidizing agent and microbiocide, useful for sterilizing air. Prior art toilet systems having odor elimination features are directed to standard-sized facilities, and the mechanisms described therein would not be adaptable for use with a bedpan, which must have a relatively “flat” configuration so as to accommodate a patient in a prone position.

Kishi et al., U.S. Pat. No. 6,081,935, discloses a portable toilet having a purifying agent producing/supplying device built into a periphery of a toilet bowl. Due to an ozone producing mechanism, a tank assembly, and a bubble generating tank, which are provided by this purifying agent producing/supplying device, when an upper cover of the toilet is opened, a purifying agent that is an aggregate of ozone-containing bubbles is supplied to an inside of the toilet bowl.

Sasaki et al., U.S. Pat. No. 6,233,749, discloses a portable toilet stool or bowl having an upper opening which is effectively closed by an air-curtain formed by currents of air flowing all over the opening to evacuate odors. One or more air suction openings are provided adjacent to the upper opening of the stool, and air is forcibly sucked into the air-suction openings by a suction fan. An ionizer is located in the air passages connected to the air suction openings to deodorize the air.

Maisch, U.S. Pat. No. 3,599,253, discloses a toilet fitting comprising a hollow seat adapted to be mounted on a toilet bowl and containing suction orifices through which air is drawn off into a suction chamber and thence to atmosphere or to an outlet pipe by an air extractor. To simplify servicing and to reduce noise the air extractor assembly comprising a fan, an electric motor and the necessary switchgear is mounted in a replaceable cartridgelike device which is housed in a hollow extension of the seat.

It is not shown or suggested in the prior art to incorporate electro-mechanical odor elimination devices into bedpans of standard dimensions. Thus, there remains a need for a improved bedpan which includes an ozone producing device in combination with an air flow assembly in order to provide a highly efficient odor elimination system constructed and arranged for use with a conventional bedpan.

### SUMMARY OF THE INVENTION

It is an objective of the invention to provide an improved bedpan having an electrically-powered odor elimination system in the form of a integral ventilation unit which incorporates a fan in combination with an ozone producing device.

It is another objective to provide an improved bedpan having an electrically powered ventilation unit which can be readily detached to allow cleaning of the bedpan. It is still another objective to provide an improved bedpan having an electrically powered ventilation unit which conforms to the configuration of the bedpan so that it does not interfere with normal use of the bedpan.

It is yet another objective of the invention to provide an improved bedpan having an electrically powered ventilation unit which is actuatable either by a manual on/off switch or a pressure sensor in the top surface of the bedpan.

It is a further objective of the invention to provide a battery-operated portable ventilation unit for toilet receptacles which incorporates a fan in combination with an ozone producing device.

It is yet a further objective of the invention to provide a portable ventilation unit which can be used with any type of toilet facility, including bedpans.

It is still a further objective of the invention to provide a portable ventilation unit for toilet receptacles which can be suspended from the side edges of the toilet receptacle.

In accordance with the above objectives, the instant invention teaches a bedpan having a ventilating means which is constructed and arranged for cooperation with ozone producing means for the purpose of odor elimination from a bedpan. A ventilated bedpan assembly in accordance with a preferred embodiment of the invention comprises a bedpan having at least one venting port in a side wall and a ventilation unit detachably connected to the bedpan at the venting port. In a preferred embodiment, a ventilation unit including a plenum chamber having at least one intake opening and an outlet port in airflow communication with said at least one venting port in the bedpan is provided. An ozonation means is disposed in the plenum chamber; and an air flow means, e.g. a fan or equivalent air movement induction means, is situated in air flow communication or disposed within the plenum chamber, in a manner effective to induce airflow through the outlet port. In the preferred embodiment, the ozonation means is an UV light fixture. An electrical power supply means (either a battery or A/C connection) is in electric communication with the ozonation means and the fan. An actuator is coupled to the electric power means, and can be a manually operated on/off switch. The actuating means can also be a pressure or proximity sensor located with respect to the top surface of the bedpan so that the electric power means is actuated, e.g. when pressure is exerted on the bedpan during use, or when the nearness of the patient to the proximity sensor completes the circuit.

The ventilation unit can be disposed in a housing having opposing openings therein to facilitate air flow through the housing, and the bedpan and the housing can respectively include mated attachment means whereby the housing and the bedpan can be selectively attached to one another.

In an alternative embodiment, a ventilation unit is connected to the bedpan via a segment of flexible hose which allows airflow from the interior of the bedpan to the ventilation unit. The ventilation unit is disposed in a housing having opposing openings therein to facilitate air flow through the housing, and includes a plenum chamber having an intake opening and an outlet port in airflow communication with the venting port, an ozonation means disposed in the plenum chamber; a fan disposed in the plenum chamber configured to induce airflow through the outlet port; electric power means in electric communication with the ozonation means and the fan, and a flexible hose having a first end peripherally attached to the venting port of the bedpan and a second end peripherally attached to the intake opening in the plenum chamber. The venting port can include a cylindrical flange portion contiguous thereto extending outwardly from the bedpan, wherein the flange is slidingly engagable with the hose.

In still another embodiment, a portable ventilation unit for a toilet receptacle having generally upright sides is provided. The portable ventilation unit comprises a plenum chamber having an intake port and an outlet port and a venting tube in airflow communication with the intake port. The venting tube having first and second ends, wherein the first end is adapted to extend into the toilet receptacle and the second end is contiguous to the intake port. An ozonation means is disposed in the plenum chamber, and a fan is disposed in the plenum chamber configured to induce airflow through the outlet port. An electrical power supply means, preferably a battery, are constructed and arranged for operative electrical communication with the ozonation means and/or the fan. The ozonation means can be a UV light fixture. The portion of the venting tube proximate the first end can have a curvilinear configuration allowing hanging engagement with the sides of the toilet receptacle. Alternatively, the unit can include hanger means which engage with the sides of the toilet receptacle.

### BRIEF DESCRIPTION OF THE FIGURES

FIG. 1 illustrates a ventilated bedpan assembly in which the bedpan is attached to the ventilation unit;

FIG. 2 illustrates the ventilated bedpan assembly of FIG. 1 in a detached arrangement;

FIG. 3 schematically illustrates the interior of the ventilation unit;

FIG. 4 is an alternative embodiment in which the ventilation unit and the bedpan are connected by a flexible hose;

FIG. 5 illustrates a hose attachment arrangement for the embodiment shown in FIG. 4;

FIG. 6 illustrates another alternative embodiment in which the ventilation unit is portable; and

FIG. 7 schematically illustrates the interior of the ventilation unit of FIG. 6.

### DETAILED DESCRIPTION OF THE INVENTION

Although the invention will be described in terms of a specific embodiment, it will be readily apparent to those skilled in this art that various modifications, rearrangements, and substitutions can be made without departing from the spirit of the invention. The scope of the invention is defined by the claims appended hereto.

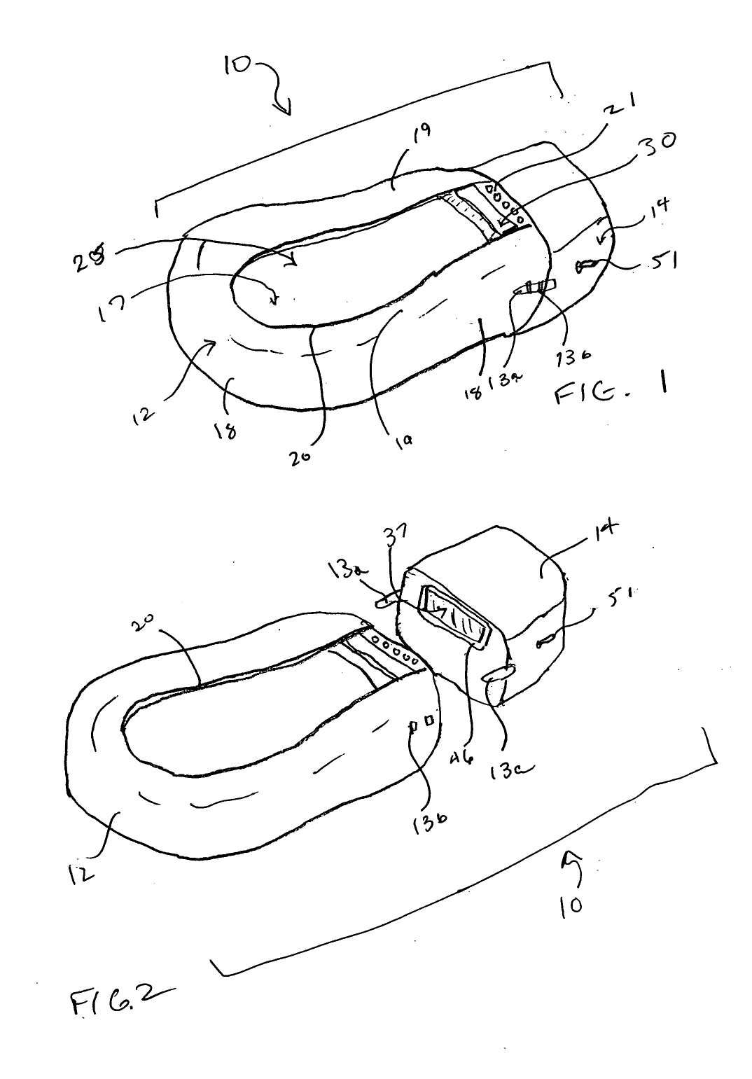

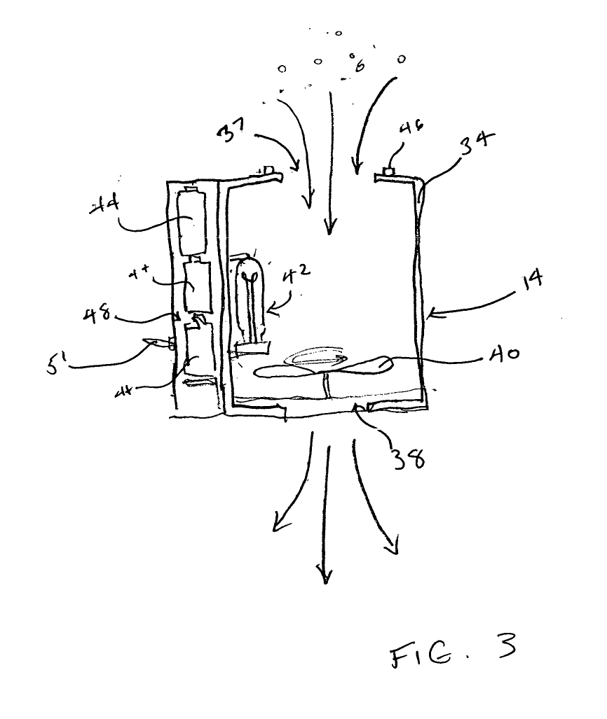

FIG. 1 illustrates a first embodiment of the ventilated bedpan assembly 10 of the invention. The bedpan assembly 10 includes a toilet receptacle in the form of a bedpan 12 which is detachably connected to a ventilation unit 14. As shown in FIG. 2, the ventilation unit can be detached from the bedpan 12 so that the bedpan 12 can be cleaned with water without damaging the ventilation unit 14. Mated attachment means, such as sliding clip fasteners 13a and 13b, are respectively disposed on the bedpan 12 and the ventilation unit 14 to allow for rapid engagement and disengagement. Any suitable attachment mechanism can be used.

The bedpan 12 has the standard configuration for the purpose and includes a bottom wall 17, generally upright side walls 18, and a top surface 19 having an opening 20 therethrough adapted to receive human waste materials, thus defining an interior void area 25 and an exterior surface 27. The side walls 18 include a venting port 21, preferably proximate the top of the bedpan 12 to avoid contamination of the ventilation unit 14. The venting port 21 can have any suitable configuration, and can be in the form of a single aperture or a plurality of apertures in an array. The side walls 18 preferably include a splash shield 30, approximately perpendicular to the side walls 18, which is located below the venting port 21 and extends into the interior void area 25. The splash shield 30 serves to prevent waste materials deposited into the void area 25 from contacting the venting port 21.

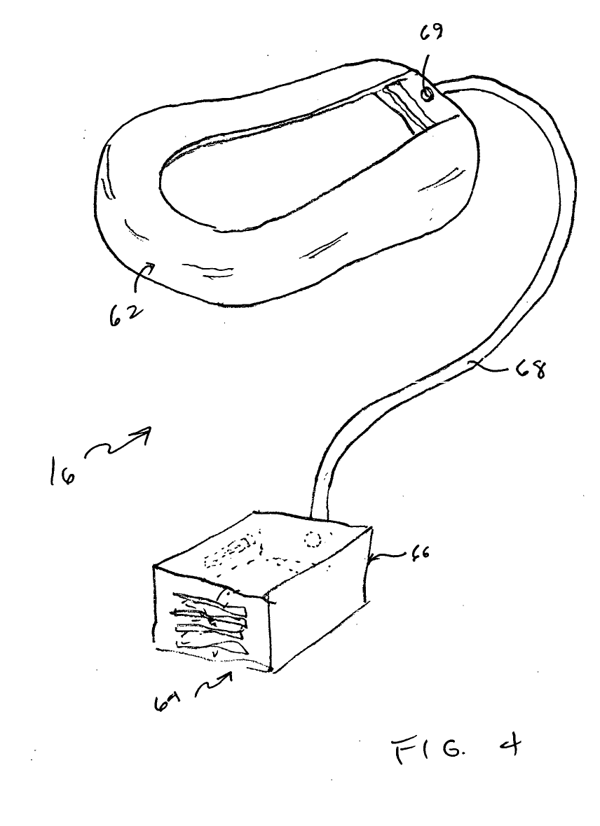

The ventilation unit 14 includes a housing 34 which preferably conforms to the configuration of the bedpan 12 so as to appear to integrally formed with the bedpan 12 when it is attached. FIG. 3 schematically illustrates the interior of ventilation unit 14. Within the housing 34 is a plenum chamber 36 having an intake port 37 and an outlet port 38. When the ventilation unit 14 is attached to the bedpan 12, the intake port 37 is in alignment with the venting port 21 of the bedpan 12. The periphery of the intake port 37 can include a sealing means, such as rubber gasket 46, to create an airtight seal between the intake port 37 and the venting port 21.

Disposed within the plenum chamber 36 is an ozonation means, such as UV light fixture 42, which includes the bulb socket and corresponding UV light bulb. A fan 40 is also disposed in the plenum chamber 36, and is configured to induce air flow through the outlet port 38. The fan 40 thus draws fouled and noxious air from the interiors void area 25 of the bedpan 12 into the plenum chamber 36, where the air is then is deodorized by UV light fixture 42 and expelled through outlet port 38. It is within the scope of the invention to also include a scented air freshener means in the form of a replaceable cartridge within the plenum chamber 36.

The fan 40 and the UV light fixture 42 are each electrically coupled to an electrical power means, such as the batteries 44. In the illustrated embodiment, the housing 34 includes a battery housing 48 which is segregated from the plenum chamber 36 and accessible through a battery housing door (not shown). The electrical power means can also be a standard A/C power connection assembly. An actuator is coupled to the electrical power means, such as the manual on/off switch 51 which is coupled to batteries 44. The actuator can also be in the form of a pressure or proximity type sensor (not shown) which is located proximate the top surface 19 of the bedpan 12 which serves to activate the fan 40 and UV light fixture 42 when the bedpan is in use.

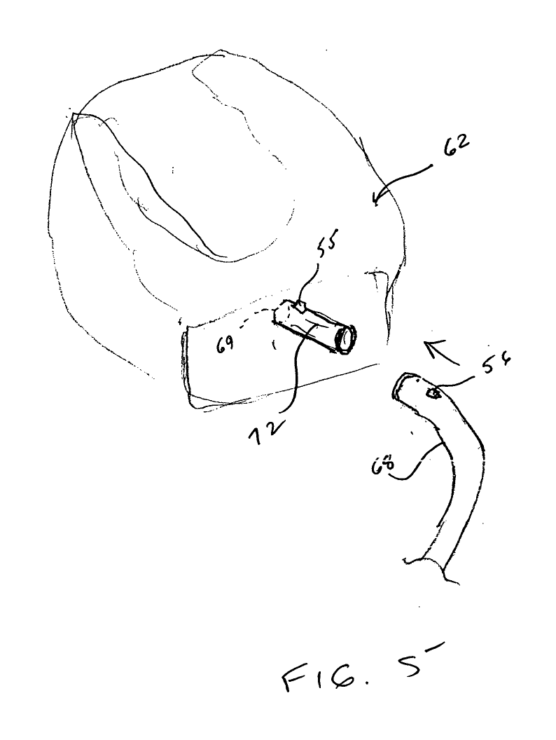

An alternative embodiment 60 of the ventilated bedpan assembly of the invention is shown in FIG. 4. In this embodiment, the ventilation unit 64 and bedpan 62 are similar in configuration to the embodiment discussed above, however the ventilation unit and the bedpan 62 are not adjoined, but are connected together by means of flexible hose 68. The ventilation unit 64 includes housing 66 having opposing openings therein to facilitate air flow through the housing 66. In this embodiment, the venting port 69 has a configuration suitable for airflow engagement with hose 68, which is peripherally attached to the venting port 69 in a substantially airtight arrangement. As shown in FIG. 5, the exterior surface of the bedpan 62 can include a cylindrical mounting flange 72 extending outwardly therefrom which circumscribes the venting port 69. The flange 72 is adapted to slidingly receive a first end of hose 68 in close engagement, and can include a spring-biased tab 55 which engages with cooperating aperture 56 in the hose 68 to allow for ready attachment and detachment.

The housing 66 has an intake port 74 which provides the intake port for the plenum chamber located within the housing 66. The intake port 74 is configured for airflow engagement with the second end of hose 68 such that the second end of hose 68 is peripherally attached to intake port 74 in an airtight arrangement.

A third embodiment of the invention is shown in FIG. 7. This embodiment, indicated as unit 80, is a portable ventilation unit for a toilet receptacle, and can be used with bedpans, portable toilets, standard toilets, or any similar type receptacle. As schematically shown in the interior view of FIG. 7, the unit 80 includes a housing 81, and a plenum chamber 82 disposed within the housing having an intake port 83 and an outlet port 84. A venting tube 86 is in airflow communication with the intake port 83, and has a first end 84 adapted to extend into a toilet receptacle with the second end 85 being contiguous to the intake port 83.

An ozonation means, such as UV light fixture 90, is disposed in the plenum chamber 82. The plenum chamber 82 also includes a fan 92 configured to induce airflow through the outlet port 84. The UV light fixture 90 and fan 92 are each coupled to a electric power means, preferably a battery power source such as batteries 94. As shown in FIG. 7, the housing 81 includes a battery housing 95 which is separate from the plenum chamber 82. The housing 81 can include a battery housing door 96 which provides access to the batteries 94. An actuator is coupled to the batteries 94, which can be in the form of the manual on/off switch 97.

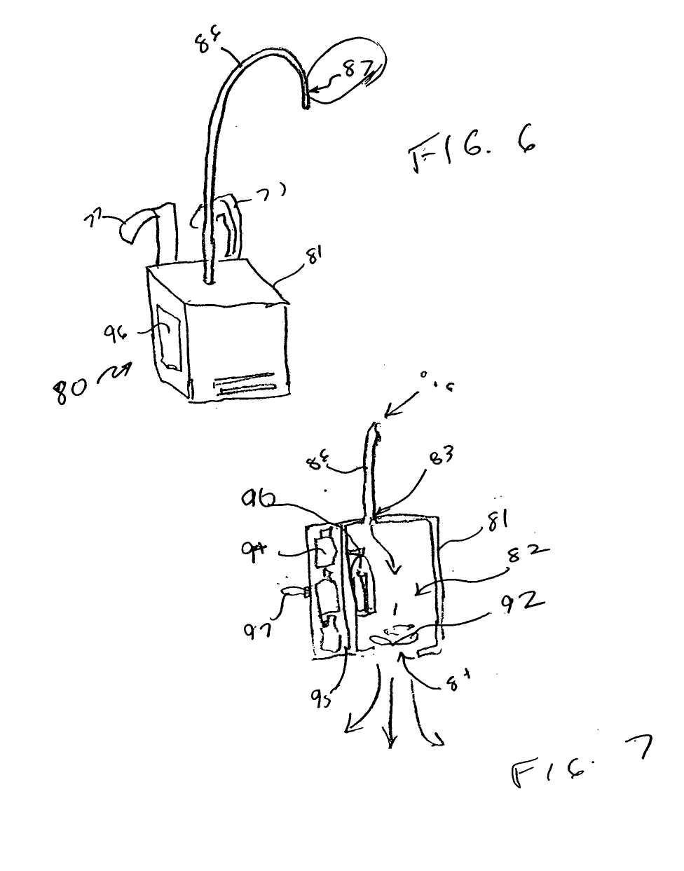

The portion of the venting tube 86 proximate the first end 87 can have a curvilinear configuration, as shown in FIG. 6, which allows hanging engagement with the sides of a toilet receptacle. The unit can also include at least a hanging means, such as hangers 77 shown in FIG. 6, which engage with the edge of the toilet receptacle to allow the venting tube 86 to extend inside the receptacle.

In use, the first end of the venting tube 86 is be positioned inside the toilet receptacle, and the unit 80 can be suspended from the edge so as to be outside of the toilet receptacle. The fan 92 and the UV light fixture 90 are actuated so that air from inside the toilet receptacle is drawn into the plenum chamber 82, where it is deodorized by the UV light fixture 90 and expelled through outlet port 94. The unit 80 can also be used with a bedpan, in which case the unit 80 is positioned so that the first end 87 of the venting tube 86 is inside the bedpan, and the unit 80 is placed outside the bedpan and then adjusted to comfortably accommodate the user. The venting tube 86 can constructed from a shapable tubular material so that the configuration can be adjusted to the optimum shape at the time of use.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A ventilated bedpan assembly, comprising:
a pan shaped receptacle having a configuration defined by a flat bottom wall, generally upright side walls, and a top surface having an opening therethrough adapted to receive human waste materials, said side surfaces including at least one venting port, said receptacle being configured for placement in an appropriate position under a prone patient by a caregiver;
a ventilation unit constructed and arranged for detachable connection to said toilet receptacle, said ventilation unit comprising:
a plenum chamber disposed in a housing securable to said receptacle in airflow communication with said at least one venting port, said plenum chamber having at least one intake port and an outlet port;
an ozonation means in airflow communication with said plenum chamber;
air flow means in said housing situated in air flow communication with said plenum chamber to induce air flow through said outlet port;
and electrical power supply means in operative communication with said ozonation means and said air flow means;
whereby actuation of said ventilation unit causes noxious gases to be withdrawn through said venting port for deodorization prior to traversing said outlet port.

2. The ventilated bed pan of claim 1, further comprising an actuator for operating said electrical power supply means.

3. The ventilated bedpan of claim 2, wherein said actuator is a manually operated on/off switch in electric communication with said electrical power supply means.

4. The ventilated bedpan of claim 2, wherein said actuator is a pressure sensor disposed in said top surface whereby said electrical power supply means is actuated by pressure exerted on said top surface or a proximity switch actuated by proximity of a user thereto.

5. The ventilated bedpan of claim 1, wherein said electrical power supply means is a battery, and said ventilation unit further comprises a battery housing.

6. The ventilated bedpan of claim 1, wherein said electrical power supply means is an A/C power connection.

7. The ventilated bedpan of claim 1, wherein said ozonation means is a UV light fixture.

8. The ventilated bedpan of claim 1, wherein said ventilation unit is disposed in a housing having opposing openings therein to facilitate air flow through said housing, and said bedpan and said housing respectively include mated attachment means whereby said housing and said bedpan can be selectively attached to one another.

9. A ventilated bedpan assembly, comprising:
a pan shaped receptacle having a bottom wall, generally upright side walls, and a top surface having an opening therethrough adapted to receive human waste materials, said side surfaces including a venting port, said bedpan being configured for placement in an appropriate position under a prone patient by a caregiver;
a ventilation unit disposed in a housing having opposing openings therein to facilitate air flow through said housing, said ventilation unit comprising:
a plenum chamber in airflow communication with said venting port, said plenum chamber having an intake port and an outlet port;
a UV light capable or producing ozone is disposed in said plenum chamber;
a fan disposed in said plenum chamber configured to induce airflow through said outlet port;
an electrical power supply means in electric communication with said ozonation means and said fan;
and a flexible hose having a first end peripherally attached to said venting port of said bedpan and a second end peripherally attached to an intake port in said plenum chamber;
whereby actuation of said ventilation unit causes noxious gases to be withdrawn through said venting port for deodorization prior to traversing said outlet port.

10. The ventilated bedpan assembly of claim 9, wherein said venting port is circumscribed by a cylindrical mounting flange portion contiguous thereto and extending outwardly from said bedpan, wherein said flange is adapted to slidingly receive said first end of said hose.

11. The ventilated bedpan assembly of claim 10, wherein said cylindrical mounting flange includes a spring-biased tab, and said first end of said hose include a cooperating aperture adapted to engage with said spring-biased tab.

12. (Canceled)

13. (Canceled)

14. (Canceled)

15. (Canceled)

16. (Canceled)

17. (Canceled)

18. (Canceled)
